(19) United States
(12) Patent Application Publication
(10) Pub. No.: US 2025/0177239 A1
(43) Pub. Date: Jun. 5, 2025

(54) ADULT SEX TOY

(71) Applicant: Zhigao Huang, Gaozhou (CN)

(72) Inventor: Zhigao Huang, Gaozhou (CN)

(21) Appl. No.: 18/750,657

(22) Filed: Jun. 21, 2024

(30) Foreign Application Priority Data
Nov. 30, 2023 (CN) 2023232524221

(51) Int. Cl. A61H 19/00; A61H 23/02

(52) U.S. Cl. CPC A61H 19/44; A61H 23/0254; A61H 2201/1215

(57) ABSTRACT

An adult sex toy, including a drive member and a sliding member. The sliding member includes a first positioning plate, rotating plates, a second positioning plate, and a serpentine rod. One end of the serpentine rod is movably assembled on the first positioning plate, and the other end of the serpentine rod is movably assembled on the second positioning plate. A plurality of rotating plates are movably sleeved on the serpentine rod, and the drive member is connected to one end of the serpentine rod and drives the serpentine rod to rotate. Driven by the serpentine rod, the rotating plates squirm in a wave form or a snake-like crawling form. This unique waveform movement brings a new sense of excitement to users, while the ups and downs of the rotating plates also simulate a real touch, bringing users a pleasant experience.

### TECHNICAL FIELD

The present invention relates to the field of adult products, and in particular to an adult sex toy.

### BACKGROUND

In daily life, people's stress is increasing day by day as the pace of life speeds up, thus their needs for stress relief are getting stronger and stronger. At the same time, with the diversified development of social thoughts, adult health care products are increasingly accepted by people, such as adult masturbation appliances.

In the prior art, all beads rotate or expand and contract rotationally together with the rotation of a motor or perform swinging actions with the curvature of a motor rotating shaft. In this way, the users' experience feeling is stiff and uncomfortable.

At the same time, the existing swing technology is to simply bend the motor rotating shaft. As the motor rotates, the motor rotating shaft rotates non-concentrically, thus obtaining the swing function. This is stiff and the users' experience feeling is uncomfortable.

To this end, we design an adult sex toy to provide another technical solution for the above technical problems.

### SUMMARY

In order to solve the above problems, the present invention provides an adult sex toy to solve the technical problems proposed in the background art.

In order to achieve the above objects, the technical solution adopted by the present invention is: an adult sex toy, including a drive member and a sliding member, the sliding member including a first positioning plate, rotating plates, a second positioning plate, and a serpentine rod, where one end of the serpentine rod is movably assembled on the first positioning plate, the other end of the serpentine rod is movably assembled on the second positioning plate, a plurality of rotating plates are movably sleeved on the serpentine rod, the drive member is connected to one end of the serpentine rod and drives the serpentine rod to rotate, and the serpentine rod drives the plurality of rotating plates to move in a waveform.

Further, extrusion hole positions are provided at the centers of the rotating plates, and the serpentine rod passes through the extrusion hole positions; and an outer side of the serpentine rod is in contact with inner sides of the extrusion hole positions and drives the rotating plates to move followingly.

Further, both sides of the rotating plates are also provided with limit sliding grooves, the sliding member further includes two limit rods which are symmetrically arranged on both sides of the serpentine rod, and one end of each of the limit rods is connected to the first positioning plate while the other end passes through the limit sliding grooves on the corresponding sides of the plurality of rotating plates and is connected to the second positioning plate.

Further, a tail end of the serpentine rod is connected with a connecting column which is provided with a connecting groove, and a drive end of the drive member is assembled with the connecting groove.

Further, the drive member further includes a drive motor and a reducer, where an output shaft of the drive motor is connected to an input end of the reducer, and an output end of the reducer is in drive connection with one end of the serpentine rod.

Further, the reducer includes a first rotating shaft, a protective shell, a support plate, a protective plate, a drive gear, a first transmission gear, a first transmission shaft, a second transmission gear, a third transmission gear, a second transmission shaft, a fourth transmission gear, a fifth transmission gear, a sixth transmission gear, a seventh transmission gear, and a transmission column; the protective shell is connected on the outer side of one end of the drive motor, the support plate is connected on the inner side of the protective shell, one end of the protective shell is connected with the protective plate, an output end of the drive motor is located on the inner side of the protective shell and has the drive gear fixed thereto, one side of the drive gear is in meshing connection with the first transmission gear, the first transmission shaft is rotationally connected inside the first transmission gear, and the first transmission shaft is rotationally connected to both the protective shell and the protective plate; the second transmission gear is fixed at one end of the first transmission gear and located on the outer side of the first transmission shaft, one side of the second transmission gear is in meshing connection with the third transmission gear, the second transmission shaft is rotationally connected inside the third transmission gear, and the second transmission shaft is rotationally connected to both the protective shell and the protective plate; the fourth transmission gear is fixed at one end of the third transmission gear and located on the outer side of the second transmission shaft, one end of the fourth transmission gear is in meshing connection with the fifth transmission gear, and the fifth transmission gear is located at one end of the second transmission gear; an inner side of the fifth transmission gear is rotationally connected to the first transmission shaft, the sixth transmission gear is fixed at one end of the fifth transmission gear and located on the outer side of the first transmission shaft, and the sixth transmission gear is rotationally connected to the support plate; one end of the support plate away from the drive motor is rotationally connected with the seventh transmission gear, and the seventh transmission gear is in meshing connection with the sixth transmission gear; and one end of the seventh transmission gear is fixed with the transmission column, the transmission column is connected to the first transmission shaft, and the first transmission shaft is assembled with the connecting groove.

Further, the diameter of the drive gear is smaller than that of the first transmission gear, the diameter of the second transmission gear is smaller than that of the first transmission gear and that of the third transmission gear, the diameter of the fourth transmission gear is smaller than that of the third transmission gear and that of the fifth transmission gear, and the diameter of the sixth transmission gear is smaller than that of the fifth transmission gear and that of the seventh transmission gear.

Further, the adult sex toy also includes an additional functional device, which is assembled on the second positioning plate, and the other end of the serpentine rod passes through the second positioning plate and is in drive connection with the additional functional device.

Further, the additional functional device is a telescopic device, which includes a first fixed shell, a rotating body, a telescopic slider, and a second follower shell; the first fixed shell is fixed to the second positioning plate, the rotating body is movably assembled in the first fixed shell, the other end of the serpentine rod is in drive connection with the rotating body so that the rotating body rotates in the first fixed shell, and the surface of the first fixed shell is provided with a linear sliding groove position; and a rolling groove is provided on the outer side of the rotating body, the second follower shell is movably sleeved on the outer surface of the first fixed shell, the telescopic slider is assembled on the surface of the second follower shell, and a connecting block at the bottom of the telescopic slider passes through the second follower shell and the linear sliding groove position and is assembled in the rolling groove.

The beneficial effects of the present invention are: when the drive member is initiated and the serpentine rod starts to rotate, the rotating plates can closely follow the motion trajectory of the serpentine rod to move, which increases the stability and smoothness of the movement. Driven by the serpentine rod, the rotating disks squirm in a wave form or a snake-like crawling form. This unique waveform movement brings a new sense of excitement to users, while the ups and downs of the rotating plates also simulate a real touch, bringing users a pleasant and comfortable experience.

### BRIEF DESCRIPTION OF THE DRAWINGS

FIG. 1 is a schematic structural diagram of the present invention;

FIG. 2 is a schematic diagram of an explosion structure of the present invention;

FIG. 3 is a schematic structural diagram of a sliding member of the present invention;

FIG. 4 is a schematic structural diagram of a serpentine rod of the present invention;

FIG. 5 is a schematic structural diagram of a rotating plate of the present invention;

FIG. 6 is a schematic structural diagram of a drive member of the present invention;

FIG. 7 is a schematic structural diagram of a reducer of the present invention;

FIG. 8 is a schematic diagram of an explosion structure in another perspective of the present invention; and

FIG. 9 is a schematic cross-sectional structural diagram of the present invention.

In the drawings: 1. Drive member; 10. Drive motor; 11. First positioning plate; 12. Rotating plate; 13. Second positioning plate; 14. Liming rod; 16. Serpentine rod; 161. Connecting column; 162. Connecting groove; 6. First rotating shaft; 18. Extrusion hole position; 19. Limit sliding groove; 20. Protective shell; 21. Support plate; 22. Protective plate; 23. Drive gear; 24. First transmission gear; 25. First transmission shaft; 26. Second transmission gear; 27. Third transmission gear; 28. Second transmission shaft; 29. Fourth transmission gear; 30. Fifth transmission gear; 31. Sixth transmission gear; 32. Seventh transmission gear; 33. Transmission column; 4. Reducer; 5. Additional functional device; 51. First fixed shell; 511. Linear sliding groove position; 52. Rotating body; 521. Rolling groove; 53. Second follower shell; 54. Telescopic slider; 541. Connecting block.

### DETAILED DESCRIPTION

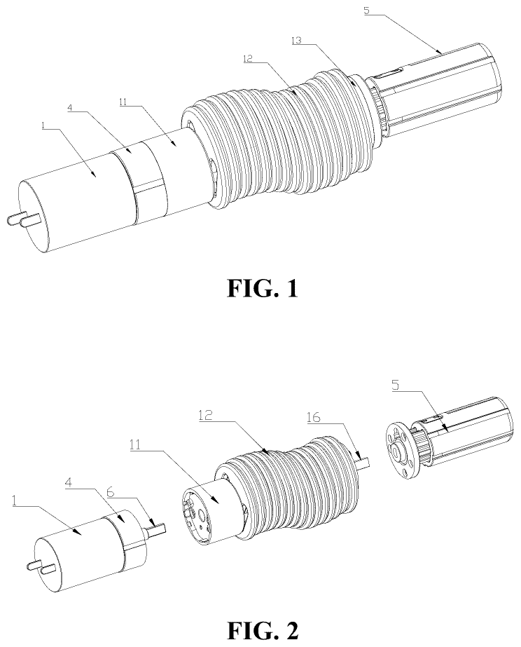

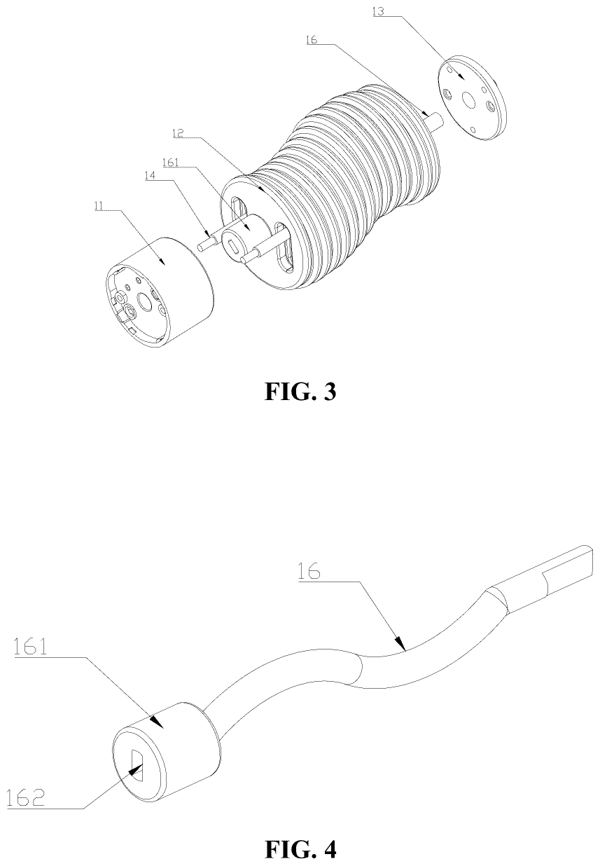

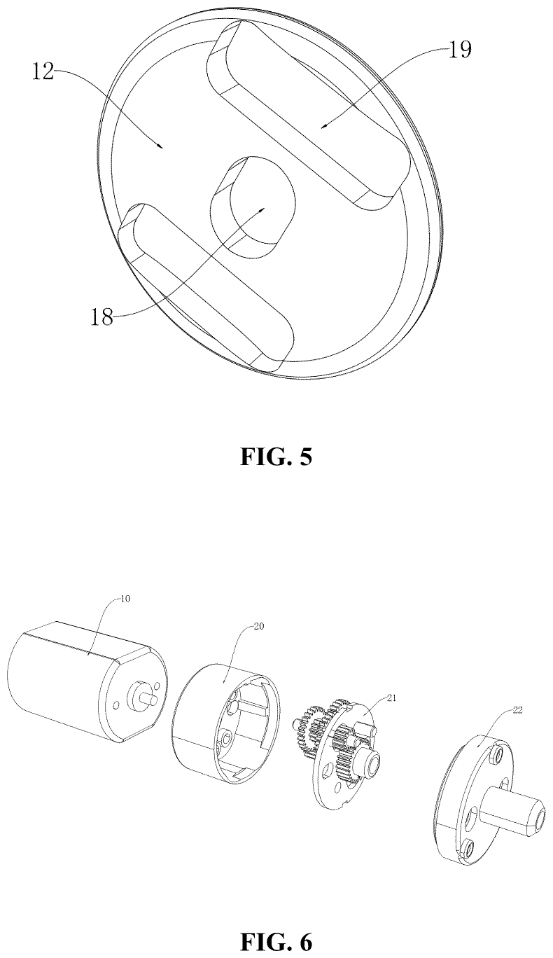

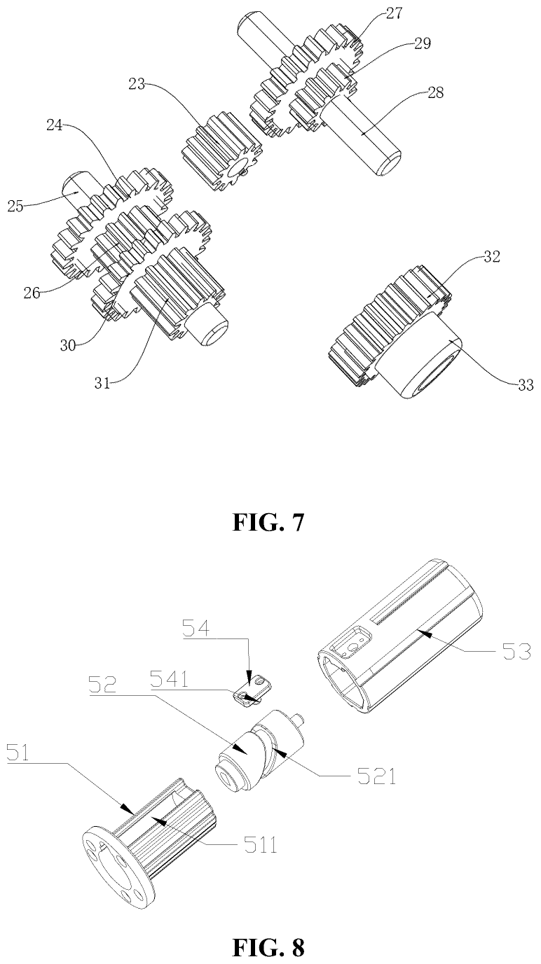

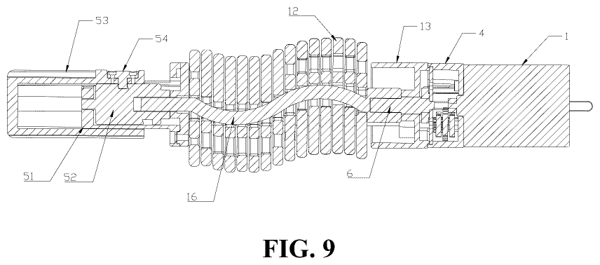

Referring to FIGS. 1-2, an adult sex toy includes a drive member 1 and a sliding member. The sliding member includes a first positioning plate 11, rotating plates 12, a second positioning plate 13, and a serpentine rod 16. One end of the serpentine rod 16 is movably assembled on the first positioning plate 11, and the other end of the serpentine rod 16 is movably assembled on the second positioning plate 13. A plurality of rotating plates 12 are movably sleeved on the serpentine rod 16, the drive member 1 is connected to one end of the serpentine rod 16 and drives the serpentine rod 16 to rotate, and the serpentine rod 16 drives the plurality of rotating plates 12 to move in a waveform.

When in use, a user can activate the drive member 1 to cause the serpentine rod 16 to rotate. This movement will drive the rotating plates 12 to squirm in a wave form or a snake-like crawling form. Each rotating plate 12 has a different position on an XY coordinate plane formed by itself at different time points, so that the actual movement of the rotating plates 12 will form stimulation nodes one by one, thus bringing a unique and pleasant experience to the user.

This product is an innovative adult sex toy, with the unique core component thereof consisting of the drive member 1 and the sliding member. In order to further improve the user's comfort and waterproof performance, a layer of soft material (TPE/silica gel, etc.) can be elaborately wrapped on the surfaces of the drive member 1 and the sliding member. This material is soft in touch and skin-friendly, and can give the user a silky tactile experience. At the same time, the material also has excellent waterproof performance, ensuring a safe user of the user in a humid environment without worrying about moisture penetration that causes product damage or affects the use effect. During use, the user will feel the softness of the material as if it were real skin. At the same time, driven by the serpentine rod 16, the adult sex toy undulates like sea waves, bringing an intoxicating sensory feast to the user. This unique waveform movement not only simulates a real touch feeling, but also brings the user a dual enjoyment of stimulation and comfort during the ups and downs of each rotating plate 12.

In this embodiment, the number of the rotating plates 12 is set as needed. At the same time, the shape of the rotating plates 12 is a circle or an outer irregular ring, and addition of objects such as beads on the circular ring or the outer irregular ring is not excluded.

Further, extrusion hole positions 18 are provided at the centers of the rotating plates 12, and the serpentine rod 16 passes through the extrusion hole positions 18. An outer side of the serpentine rod 16 is in contact with inner sides of the extrusion hole positions 18 and drives the rotating plates 12 to move followingly.

It is particularly worth mentioning that the center of each rotating plate 12 is provided with one extrusion hole position 18, and the serpentine rod 16 cleverly passes through these hole positions. When the drive member 1 is initiated and the serpentine rod 16 starts to rotate, the outer side of the serpentine rod 16 will be in close contact with the inner sides of the extrusion hole positions 18 and produce a slight extrusion effect. This extrusion effect not only ensures that the rotating plates 12 can closely follow the movement trajectory of the serpentine rod 16, but also increases the stability and smoothness of the movement. Driven by the serpentine rod 16, the rotating plates 12 squirm in a wave form or a snake-like crawling form. This unique waveform movement brings a new sense of stimulation to the user, while the ups and downs of the rotating plates 12 also simulate a real touch feeling, bringing the user a pleasant and comfortable experience.

Further, both sides of the rotating plates 12 are also provided with limit sliding grooves 19, the sliding member further includes two limit rods 14 which are symmetrically arranged on both sides of the serpentine rod 16, and one end of each of the limit rods 14 is connected to the first positioning plate 11 while the other end passes through the limit sliding grooves 19 on the corresponding sides of the plurality of rotating plates 12 and is connected to the second positioning plate 13.

Specifically, both sides of each rotating plate 12 are provided with the limit sliding grooves 19. These limit sliding grooves 19 not only provide space for the rotating plates 12 to move, but also set clear boundaries for the rotating plates 12. The sliding member contains two limit rods 14 which are symmetrically arranged on both sides of the serpentine rod 16. One end of each limit rod 14 is connected to the first positioning plate 11, while the other end passes through the limit sliding grooves 19 on the corresponding sides of all the rotating plates 12 and is tightly connected to the second positioning plate 13.

The length and width of the limit sliding grooves 19 determine the maximum displacement of the rotating plates 12. When the limit rods 14 slide in the groove to the end of the groove, the movement of the rotating plates 12 will stop, thereby ensuring that the rotating plates 12 will not exceed a preset range of movement. The limit rods 14 sliding in the limit sliding grooves 19 may ensure that the rotating plates 12 always remain on a stable trajectory during movement, thus avoiding inconvenient or uncomfortable use caused by deflection or shaking. This design avoids potential safety risks caused by excessive movement of the rotating plates 12, such as overstimulation, thereby ensuring the user's safety and comfort during use.

Further, a tail end of the serpentine rod 16 is connected with a connecting column 161 which is provided with a connecting groove 162, and a drive end of the drive member 1 is assembled with the connecting groove 162.

The connecting groove 162 is provided on the connecting column 161, and the shape and size of the connecting groove 162 perfectly match that of the drive end of the drive member 1. When the drive member 1 is initiated, the drive end thereof can be accurately inserted into the connecting groove 162, thereby ensuring that the serpentine rod 16 can move according to instructions of the drive member 1. The design of the connecting column 161 and the connecting groove 162 makes the connection between the serpentine rod 16 and the drive member 1 more secure. Under the action of the drive member 1, the serpentine rod 16 can rotate stably without shaking or deflecting. This stability not only ensures the movement accuracy of the toy, but also improves the user experience. The assembly method of the connecting column 161 and the connecting groove 162 makes the installation and disassembly process simple and quick. The user can easily connect the drive member 1 to the serpentine rod 16 without using complicated tools or performing cumbersome operations. This design not only is user-friendly, but also reduces the maintenance cost of the toy.

Further, the drive member 1 further includes a drive motor 10 and a reducer 4. An output shaft of the drive motor 10 is connected to an input end of the reducer 4, and an output end of the reducer 4 is in drive connection with one end of the serpentine rod 16.

The drive motor 10 is the power source of the entire drive member 1, and the output shaft thereof is connected to the input end of the reducer 4 through a specific connection method (such as a coupling or direct connection). When the motor is initiated, continuous torque will be generated and transmitted to the serpentine rod 16 through the reducer 4, thereby driving the rotating plates 12 to move.

The existence of the reducer 4 is to reduce the output speed of the drive motor 10 and to increase the output torque accordingly. This is because the movement of the serpentine rod 16 does not require a high speed but requires a relatively high torque to ensure sufficient power transmission and movement stability. The output end of the reducer 4 is in drive connection with one end of the serpentine rod 16 to ensure that power can be transmitted to the serpentine rod 16 smoothly and effectively.

Further, the reducer 4 includes a first rotating shaft 6, a protective shell 20, a support plate 21, a protective plate 22, a drive gear 23, a first transmission gear 24, a first transmission shaft 25, a second transmission gear 26, a third transmission gear 27, a second transmission shaft 28, a fourth transmission gear 29, a fifth transmission gear 30, a sixth transmission gear 31, a seventh transmission gear 32, and a transmission column 33. The protective shell 20 is connected on the outer side of one end of the drive motor 10, the support plate 21 is connected on the inner side of the protective shell 20, one end of the protective shell 20 is connected with the protective plate 22, an output end of the drive motor 10 is located on the inner side of the protective shell 20 and has the drive gear 23 fixed thereto, one side of the drive gear 23 is in meshing connection with the first transmission gear 24, the first transmission shaft 25 is rotationally connected inside the first transmission gear 24, and the first transmission shaft 25 is rotationally connected to both the protective shell 20 and the protective plate 22. The second transmission gear 26 is fixed at one end of the first transmission gear 24 and located on the outer side of the first transmission shaft 25, one side of the second transmission gear 26 is in meshing connection with the third transmission gear 27, the second transmission shaft 28 is rotationally connected inside the third transmission gear 27, and the second transmission shaft 28 is rotationally connected to both the protective shell 20 and the protective plate 22. The fourth transmission gear 29 is fixed at one end of the third transmission gear 27 and located on the outer side of the second transmission shaft 28, one end of the fourth transmission gear 29 is in meshing connection with the fifth transmission gear 30, and the fifth transmission gear 30 is located at one end of the second transmission gear 26. An inner side of the fifth transmission gear 30 is rotationally connected to the first transmission shaft 25, the sixth transmission gear 31 is fixed at one end of the fifth transmission gear 30 and located on the outer side of the first transmission shaft 25, and the sixth transmission gear 31 is rotationally connected to the support plate 21. One end of the support plate 21 away from the drive motor 10 is rotationally connected with the seventh transmission gear 32, and the seventh transmission gear 32 is in meshing connection with the sixth transmission gear 31. One end of the seventh transmission gear 32 is fixed with the transmission column 33, the transmission column 33 is connected to the first transmission shaft 6, and the first transmission shaft 6 is assembled with the connecting groove 162.

Further, the diameter of the drive gear 23 is smaller than that of the first transmission gear 24, the diameter of the second transmission gear 26 is smaller than that of the first transmission gear 24 and that of the third transmission gear 27, the diameter of the fourth transmission gear 29 is smaller than that of the third transmission gear 27 and that of the fifth transmission gear 30, and the diameter of the sixth transmission gear 31 is smaller than that of the fifth transmission gear 30 and that of the seventh transmission gear 32.

When the apparatus provided by this embodiment needs the sliding member to work, the drive motor 10 is powered on to allow the drive motor 10 to work, thus driving the drive gear 23 to rotate. The rotation of the drive gear 23 drives the first transmission gear 24 in meshing connection to rotate, allowing the first transmission gear 24 to drive the second transmission gear 26 to rotate synchronously on the outer side of the first transmission shaft 25, allowing the rotation of the second transmission gear 26 to drive the fourth transmission gear 29 to rotate through the third transmission gear 27 in meshing connection, allowing the rotation of the fourth transmission gear 29 to drive the sixth transmission gear 31 to rotate through the fifth transmission gear 30 in meshing connection, and allowing the rotation of the sixth transmission gear 31 to drive the transmission column 33 to rotate through the seventh transmission gear 32 in meshing connection. The transmission column 33 drives the first rotating shaft 6 to rotate, thus driving the sliding member.

Further, the adult sex toy also includes an additional functional device 5, which is assembled on the second positioning plate 13. The other end of the serpentine rod 16 passes through the second positioning plate 13 and is in drive connection with the additional functional device 5.

Further, the additional functional device is a telescopic device, which includes a first fixed shell 51, a rotating body 52, a telescopic slider 54, and a second follower shell 53. The first fixed shell 51 is fixed to the second positioning plate 13, the rotating body 52 is movably assembled in the first fixed shell 51, and the other end of the serpentine rod 16 is in drive connection with the rotating body 52 so that the rotating body 52 rotates in the first fixed shell 51, and the surface of the first fixed shell 51 is provided with a linear sliding groove position 511. A rolling groove 521 is provided on the outer side of the rotating body 52, the second follower housing 53 is movably sleeved on the outer surface of the first fixed shell 51, the telescopic slider 54 is assembled on the surface of the second follower shell 53, and a connecting block 541 at the bottom of the telescopic slider 54 passes through the second follower shell 53 and the linear sliding groove position 511 and is assembled in the rolling groove 521.

Specific working principles of the telescopic device:

In an initial state, the telescopic slider 54 is located at a certain position of the linear sliding groove position 511 of the first fixed shell 51, usually one end or a middle position of the groove position. The connecting block 541 is located in the rolling groove 521 at the outer side of the rotating body 52. The other end of the serpentine rod 16 is in drive connection with the rotating body 52. When the serpentine rod 16 is driven to rotate, the rotating body 52 is driven to rotate in the first fixed shell 51.

When the rotating body 52 rotates, the rolling groove 521 on the outer side thereof will rotate accordingly. Since the connecting block 541 is located in the rolling groove 521, the rotation of the rolling groove 521 will cause the connecting block 541 to move along the trajectory of the rolling groove 521. This movement trajectory is usually arc-shaped, but since the connecting block 541 is limited to the linear sliding groove position 511, this arc-shaped motion will be converted into a linear motion.

Elaborated specifically, the design of the rolling groove 521 will adopt an asymmetric wave or curve shape. This shape will enable the connecting block 541 to move along different parts of the rolling groove 521 when the rotating body 52 is rotating, thereby driving the telescopic slider 54 to slide back and forth on the linear sliding groove position 511.

The specific design is as follows: with regard to the asymmetrical wave rolling groove 521, the rolling groove 521 is designed as an asymmetric waveform, with one half cycle of the waveform (e.g., from wave peak to wave trough) corresponding to one movement direction of the telescopic slider 54, while the other half cycle corresponding to the opposite direction. With regard to the starting position, the connecting block 541 is initially located at a certain location in the rolling groove 521, such as the midpoint of the waveform or the starting point of a specific design. With regard to the one-way rotation of the rotating body 52: when the rotating body 52 is driven by the serpentine rod 16 to rotate in one direction, the connecting block 541 will move along the waveform trajectory of the rolling groove 521.

As the rotating body 52 rotates, the connecting block 541 will move on different parts of the rolling groove 521. In the rising part of the waveform, the connecting block 541 will push the telescopic slider 54 to move in one direction. However, in the descending part of the waveform, although the rotating body 52 is still rotating in the same direction, the connecting block 541 will move in the opposite direction under the guidance of the rolling groove 521, thereby driving the telescopic slider 54 to return to the starting position or another position.

As the rotating body 52 continues to rotate, the connecting block 541 will move cyclically on the waveform trajectory of the rolling groove 521, thereby driving the telescopic slider 54 to slide back and forth on the linear sliding groove position 511.

It is to be specially noted that in this specific embodiment, the additional functional device realizes the telescopic function, but this design has extremely high flexibility and expandability. We also provide a variety of functional modules for the adult sex toy, which can be skillfully combined with the sliding member whether a buckle, swinging, vibration or other functions are provided, thus providing the user with a richer and more diverse experience.

In order to expand these functions, we can adopt a modular design concept. Each function can be regarded as an independent module, and they are connected through standard interfaces. In this way, the user can selectively add or replace different functional modules according to their own needs and preferences, thereby customizing products that meet their personal preferences.

The patented technology of the present invention not only is applicable to the field of adult sex toys, but also can be widely used in various types of sex toy products such as anal masturbators, prostate massagers, female masturbation sticks, female wearable masturbators, and male masturbators. Similarly, this innovative technology can also be applied to the field of massage-related products. These applications are all based on the unique design and functions of the present invention, bringing the user a richer and more personalized experience. Through continuous technological innovation and product optimization, the present invention will show great potential and value in the fields of adult sex toys and massage products.

The above embodiments are only descriptions of preferred embodiments of the present invention, and do not limit the scope of the present invention. Without departing from the design spirit of the present invention, various modifications and improvements made to the technical solutions of the present invention by ordinary engineers and technicians in the art should fall within the protection scope determined by the claims of the present invention.

What it claimed is:

1. An adult sex toy, comprising a drive member and a sliding member, the sliding member comprising a first positioning plate, rotating plates, a second positioning plate, and a serpentine rod, wherein one end of the serpentine rod is movably assembled on the first positioning plate, the other end of the serpentine rod is movably assembled on the second positioning plate, a plurality of rotating plates are movably sleeved on the serpentine rod, and the drive member is connected to one end of the serpentine rod and drives the serpentine rod to rotate.

2. The adult sex toy according to claim 1, wherein extrusion hole positions are provided at the centers of the rotating plates, and the serpentine rod passes through the extrusion hole positions; and an outer side of the serpentine rod is in contact with inner sides of the extrusion hole positions and drives the rotating plates to move followingly.

3. The adult sex toy according to claim 2, wherein both sides of the rotating plates are also provided with limit sliding grooves, the sliding member further comprises two limit rods which are symmetrically arranged on both sides of the serpentine rod, and one end of each of the limit rods is connected to the first positioning plate while the other end passes through the limit sliding grooves on the corresponding sides of the plurality of rotating plates and is connected to the second positioning plate.

4. The adult sex toy according to claim 2, wherein a tail end of the serpentine rod is connected with a connecting column which is provided with a connecting groove, and a drive end of the drive member is assembled with the connecting groove.

5. The adult sex toy according to claim 4, wherein the drive member further comprises a drive motor and a reducer, an output shaft of the drive motor is connected to an input end of the reducer, and an output end of the reducer is in drive connection with one end of the serpentine rod.

6. The adult sex toy according to claim 5, wherein the reducer comprises a first rotating shaft, a protective shell, a support plate, a protective plate, a drive gear, a first transmission gear, a first transmission shaft, a second transmission gear, a third transmission gear, a second transmission shaft, a fourth transmission gear, a fifth transmission gear, a sixth transmission gear, a seventh transmission gear, and a transmission column; the protective shell is connected on the outer side of one end of the drive motor, the support plate is connected on the inner side of the protective shell, one end of the protective shell is connected with the protective plate, an output end of the drive motor is located on the inner side of the protective shell and has the drive gear fixed thereto, one side of the drive gear is in meshing connection with the first transmission gear, the first transmission shaft is rotationally connected inside the first transmission gear, and the first transmission shaft is rotationally connected to both the protective shell and the protective plate; the second transmission gear is fixed at one end of the first transmission gear and located on the outer side of the first transmission shaft, one side of the second transmission gear is in meshing connection with the third transmission gear, the second transmission shaft is rotationally connected inside the third transmission gear, and the second transmission shaft is rotationally connected to both the protective shell and the protective plate; the fourth transmission gear is fixed at one end of the third transmission gear and located on the outer side of the second transmission shaft, one end of the fourth transmission gear is in meshing connection with the fifth transmission gear, and the fifth transmission gear is located at one end of the second transmission gear; an inner side of the fifth transmission gear is rotationally connected to the first transmission shaft, the sixth transmission gear is fixed at one end of the fifth transmission gear and located on the outer side of the first transmission shaft, and the sixth transmission gear is rotationally connected to the support plate; one end of the support plate away from the drive motor is rotationally connected with the seventh transmission gear, and the seventh transmission gear is in meshing connection with the sixth transmission gear; and one end of the seventh transmission gear is fixed with the transmission column, the transmission column is connected to the first transmission shaft, and the first transmission shaft is assembled with the connecting groove.

7. The adult sex toy according to claim 5, wherein the diameter of the drive gear is smaller than that of the first transmission gear, the diameter of the second transmission gear is smaller than that of the first transmission gear and that of the third transmission gear, the diameter of the fourth transmission gear is smaller than that of the third transmission gear and that of the fifth transmission gear, and the diameter of the sixth transmission gear is smaller than that of the fifth transmission gear and that of the seventh transmission gear.

8. The adult sex toy according to claim 1, further comprising an additional functional device, which is assembled on the second positioning plate, wherein the other end of the serpentine rod passes through the second positioning plate and is in drive connection with the additional functional device.

9. The adult sex toy according to claim 8, wherein the additional functional device is a telescopic device, which comprises a first fixed shell, a rotating body, a telescopic slider, and a second follower shell; the first fixed shell is fixed to the second positioning plate, the rotating body is movably assembled in the first fixed shell, the other end of the serpentine rod is in drive connection with the rotating body so that the rotating body rotates in the first fixed shell, and the surface of the first fixed shell is provided with a linear sliding groove position; and a rolling groove is provided on the outer side of the rotating body, the second follower shell is movably sleeved on the outer surface of the first fixed shell, the telescopic slider is assembled on the surface of the second follower shell, and a connecting block at the bottom of the telescopic slider passes through the second follower shell and the linear sliding groove position and is assembled in the rolling groove.
